(19) United States
(12) Patent Application Publication
(10) Pub. No.: US 2005/0048952 A1
(43) Pub. Date: Mar. 3, 2005

(54) Method and apparatus for distribution of cipher code in wireless LAN

(76) Inventors: Tsuneo Saito, Kawasaki (JP); Takashi Maruyama, Ebina (JP); Jun Saito, Sagamihara (JP); Hitoshi Yokota, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/930,780

(22) Filed: Sep. 1, 2004

(30) Foreign Application Priority Data
Sep. 1, 2003 (JP) 2003-308755

(51) Int. Cl. H04M 3/16

(52) U.S. Cl. 455/411; 455/410

(57) ABSTRACT

A method for distributing a cipher code in a wireless network system including a mobile terminal and a fixed station includes the steps of making a registration request from a mobile terminal to the fixed station as a terminal with which communication is to be made, changing a communication range of the fixed station in accordance with the registration request and distributing an initial cipher code from the fixed station to the mobile terminal while the communication range changed. It is possible to safely make initial registration of a user and to distribute a cipher code used for communication by use of a fixed station alone, to limit the cost of an entire system and to reduce burden to a manager.

The present application claims priority from Japanese application JP2003-308755 filed on Sep. 1, 2003, the content of which is hereby incorporated by reference into this application.

### BACKGROUND OF THE INVENTION

1. Field of the Invention

This invention relates to a method for distributing a cipher code and a wireless network system. More particularly, the invention relates to a method for distributing a cipher code and a wireless network system that are employed for safely transmitting the cipher code that is first used for communication between a fixed base station and a wireless terminal and automatically update the cipher code used for subsequent normal communication.

2. Description of the Related Art

When communication is made from a wireless terminal in wireless network systems in general, physical connection such as plug-in of a cable into a port of the terminal is not necessary and the possibility is high in that a third party unnoticeably establishes connection with a fixed base station. Therefore, ordinary wireless networks generally set a cipher code for each fixed base station and inhibits connection with the fixed base station unless the wireless terminal uses the same cipher code as the cipher code so set. However, because the fixed base station wireless transmits the cipher code when the wireless terminal first connects to the fixed base station, wireless terminals in the proximity of the fixed base station may intercept and acquire the cipher code.

### SUMMARY OF THE INVNTION

A communication method based on the standard called “IEEE802.1x” is known as a technology capable of solving the problem described above. This technology can execute both authentication of users and automatic updating of cipher codes.

FIG. 11 of the accompanying drawings is a block diagram showing a structural example of a wireless network system according to the technology that uses the IEEE802.1x standard. In FIG. 11, reference numeral 701 denotes a fixed base station. Reference numerals 702a to 702c denote wireless terminals. Reference numeral 703 denotes a wire network. Reference numeral 704 denotes an authentication server.

The wireless network system shown in FIG. 11 represents an example of wireless LAN and includes the fixed base station 701, the authentication server 704 connected through the wire network 703 and the wireless terminals 702a to 702c capable of receiving services such as acquisition of various kinds of information through the fixed base station 701.

Next, a cipher code distribution procedure in the IEEE802.1x standard will be explained. In the system shown in FIG. 11, a manager of the system registers in advance users of wireless LAN to the authentication server 704. When a wireless connection request occurs from the wireless terminal of the user to the fixed base station 701, the fixed base station 701 communicates with the authentication server 704 through the wire network 703 and distributes a cipher code from the fixed base station 701 to the user's terminal for which authentication proves successful. In this case, a cipher code different for each user is distributed. The user uses the wireless terminal by the cipher code and executes encryption communication but the cipher code is automatically updated after the passage of an arbitrary time and communication is continued. Because the cipher code is updated in this way in an arbitrary interval, it becomes difficult for a third party to decrypt the cipher code.

The technology that utilizes the IEEE802.1x described above has the merit that the cipher code cannot be intercepted easily. The operation can be made in a user environment fixed to a certain extent where the user information is unitarily managed by the authentication server 704 and distribution of security information such as the cipher code is made separately. Preferably, however, the system can be utilized in a use environment in which an indefinite and large number of users can instantly make registration and can start utilization.

To automatically update the cipher code, the technology described above needs a server for authenticating the users besides the wireless apparatus as the fixed base station, and the cost of the overall system is preferably reduced. The server needs maintenance management and labor for this purpose is preferably eliminated. When a public wireless connection service is made for an indefinite number of users, it is preferred that the users can instantly start connection and utilize the network. Furthermore, the technology described above needs an initial cipher code for the first connection after the user is registered. The user must receive the report of this cipher code from the manager of the network and must separately sets the cipher code to the wireless terminal. This trouble is preferably eliminated, too.

It is a first object of the invention to provide a method for distributing cipher codes and a wireless network system that can solve the problems of the prior technology described above, can generate the cipher codes by using only a wireless apparatus as a fixed base station, can automatically update the cipher codes, can immediately register the users upon users' request and can wireless generate the initial cipher codes.

The objects described above can be accomplished by a method for distributing a cipher code in a wireless network system including one or a plurality of fixed base stations, for executing communication between the fixed base stations and wireless terminals by using the cipher code, wherein the fixed base station receiving an initial registration request generated by the wireless terminal lowers a wireless output of its own fixed base station to such an intensity that communication can be made in only an area extremely close to the own fixed base station, registers the wireless terminal making the initial registration request and distributes the cipher code to the wireless terminal.

The objects described above can be accomplished by a method for distributing a cipher code in a wireless network system including one or a plurality of fixed base stations, for executing communication between the fixed base stations and wireless terminals by using the cipher code, wherein a fixed base station for initial registration the intensity of which is lowered to such an intensity that communication can be made in only an area extremely close to the own fixed base station is disposed inside the wireless network system, receives an initial registration request generated by the wireless terminal, registers the wireless terminal making the initial registration request and distributes the cipher code to the wireless terminal.

The objects described above can be accomplished by a wireless network system having one or a plurality of fixed base stations, for executing wireless communication between a fixed base station and a wireless terminal by using a cipher code, wherein the wireless network system includes means for lowering a wireless output of its own fixed base station to such a level that communication can be made in only an area extremely close to the own fixed base station when at least one of the fixed base stations receives an initial registration request generated by the wireless terminal and means for registering the wiring terminal making the initial registration request under the state where the wireless output is lowered, and distributes the cipher code to the wire terminal.

### BRIEF DESCRIPTION OF THE DRAWINGS

FIG. 1 is a block diagram showing a basic construction of a wireless network system according to a first embodiment of the invention;

FIG. 2 is a block diagram showing a structural example of an output variable fixed base station;

FIG. 3 is a diagram showing a construction of a wireless output control circuit packaged to a last stage output circuit of a wireless communication portion;

FIG. 4 is a sequence diagram useful for explaining a registration procedure of a user in the output variable fixed base station;

FIG. 5 is an explanatory view of a hidden terminal;

FIG. 6 is a sequence diagram useful for explaining a procedure for updating a cipher code distributed at the time of initial registration explained above;

FIG. 7 is a block diagram showing a basic construction of a wireless network system according to a second embodiment of the invention;

FIG. 8 is a block diagram showing a structural example of a fixed base station for initial registration:

FIG. 9 is a block diagram showing a structural example of the fixed base station;

FIG. 10 is a flowchart useful for explaining a connection permission procedure when a connection request exists from a wireless terminal to the fixed base station 107; and

FIG. 11 is a block diagram showing a structural example of a wireless network system using the IEEE802.1x standard.

### DESCRIPTION OF THE EMBODIMENTS

A cipher code distribution system and a wireless network system according to the invention will be explained hereinafter in detail with reference to the accompanying drawings.

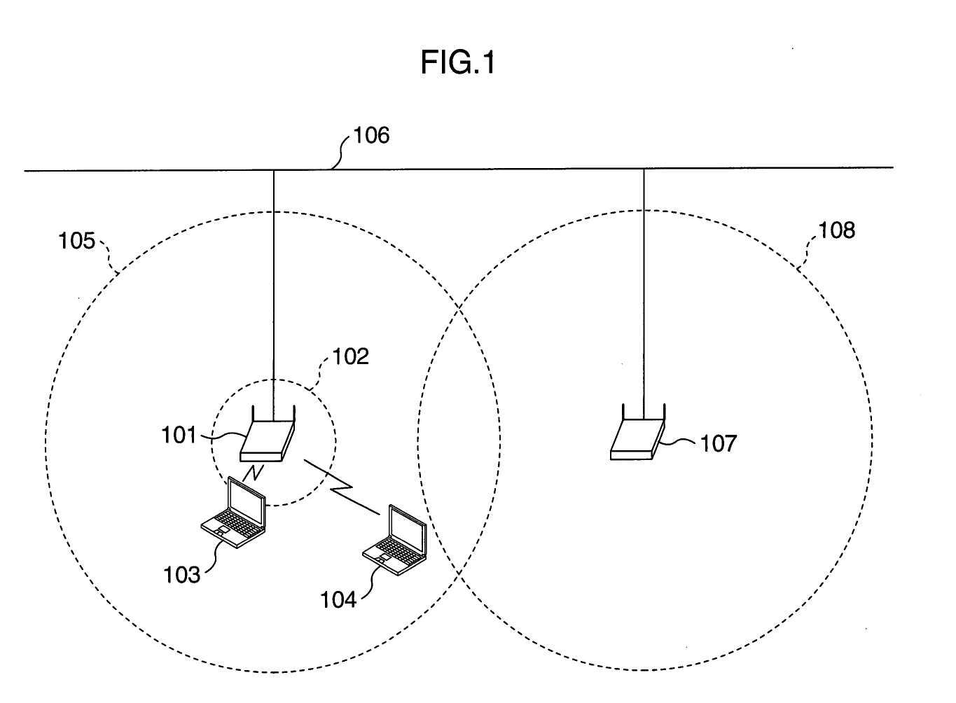

FIG. 1 is a block diagram showing a basic construction of a wireless network system according to a first embodiment of the invention. In FIG. 1, reference numeral 101 denotes an output variable fixed base station. Reference numeral 102 denotes a communication area for initial registration. Reference numerals 103, 104 and 109 denote wireless terminals. Reference numeral 105 and 108 denote a normal communication area. Reference numeral 106 denotes a wire network and reference numeral 107 denotes a fixed base station.

The wireless network system shown in FIG. 1 represents an example of a system that executes initial registration of a user by using the output variable fixed base station, distributes cipher codes and can further update automatically the cipher codes. The output variable fixed base station 101 is connected to other base station 107 through the wire network 106 and the wireless terminals 103, 104 and 109 executing communication through these base stations 101 and 107 are arranged movably. FIG. 1 shows only two fixed base stations, that is, the output variable fixed base station 101 and the fixed base station 107, but the system according to the invention may include a greater number of base stations.

The output variable fixed base station 101 has a function of lowering a wireless output at the time of registration of the wireless terminal to such an extent that communication can be made within only the communication area 102 for initial registration. The output variable fixed base station may be a terminal adaptor, an access point of wireless LAN, and so forth, for example. The output variable fixed base station is connected to other base station through the wire network 106, is also connected to other network such as the Internet to communicate with the wireless terminals and provides various kinds of information services to the wireless terminals through the Internet, or the like. The wireless terminals 103, 104 and 109 may be a personal computer equipped with a wireless LAN interface, peripheral devices, and so forth, for example. The fixed base station 107 may have the same construction as that of the output variable fixed base station 101. Generally, however, the fixed base station 107 executes only the communication services to the wireless terminals inside the communication area 108 but need not have the function of executing initial registration of the wireless terminals. The output variable fixed base station 101 can switch the communication area 102 for initial registration and the normal communication area 105.

In the system according to the first embodiment of the invention described above, the output variable fixed base station 101 is a fixed base station that is used for initial registration. The system according to this embodiment of the invention may be constituted by using a later-appearing fixed base station for initial registration in place of the output variable fixed base station 101. In the embodiment shown in FIG. 1, it is necessary for the user to carry the wireless terminal 103 into the communication area 102 for initial registration. Therefore, the fixed base station used for initial registration must be set up at a place at which the user can bring the wireless terminal close to the fixed base station and can make registration. When the system is set up inside a shop such as a restaurant, for example, the fixed base station used for initial registration is preferably set up close to a cash register.

The user acquires registration permission of the wireless terminal 103 from a system manager and receives information necessary for registration such as an address of a base station used for initial registration and a password. The user establishes connection with the fixed base station used for initial registration by using the address and the password and makes an initial registration request. After receiving the registration request, the fixed base station used for initial registration creates a communication area for initial registration having a reduced communicable area by lowering the wireless output and makes it possible to execute communication only inside this communication area 102 for initial registration. Consequently, the user can make initial registration by carrying the wireless terminal 103 into the communication area 102 for initial registration.

In contrast, those wireless terminals which do not acquire the permission of initial registration cannot generate the registration request. In addition, initial registration can be made only inside the communication area 102 for initial registration. Therefore, initial registration information cannot be intercepted unless the wireless terminal is taken into the communication area 102 for initial registration. In other words, the radius of the communication area 102 for initial registration may well be limited to about 50 cm so that the users who do not acquire the initial registration permission can be inhibited from entering the communication area 102 for initial registration. When the communication area 102 for initial registration is limited to the near distance in this way, the cipher codes can be distributed safely and reliably to the wireless terminals acquiring the permission of registration. After initial registration is complete, the user making the initial registration can start encryption communication by receiving the cipher code from the fixed base station used for initial registration.

In the system described above, the user or the manager can decide at the time of registration the term in which the registration information of the user is stored in the fixed base station. The user can connect to the fixed base station during this term on the basis of the registration information already available without making re-registration. After this predetermined period passes, registration becomes invalid and the user must register once again. Therefore, the registration status of the user can be managed.

When an indefinite number of users are handled, the aforementioned system for authentication using the authentication server involves the problems that user management by the manager is extremely complicated and difficult and convenience to the users is low, too. In contrast, the system according to this embodiment can reduce the burden of the manager and can improve convenience for the users. The system of this embodiment is effective particularly in an environment in which an indefinite and large number of users use the system such as the case where the wireless network is opened for a day for purchasers of coffee in a coffee shop, for example.

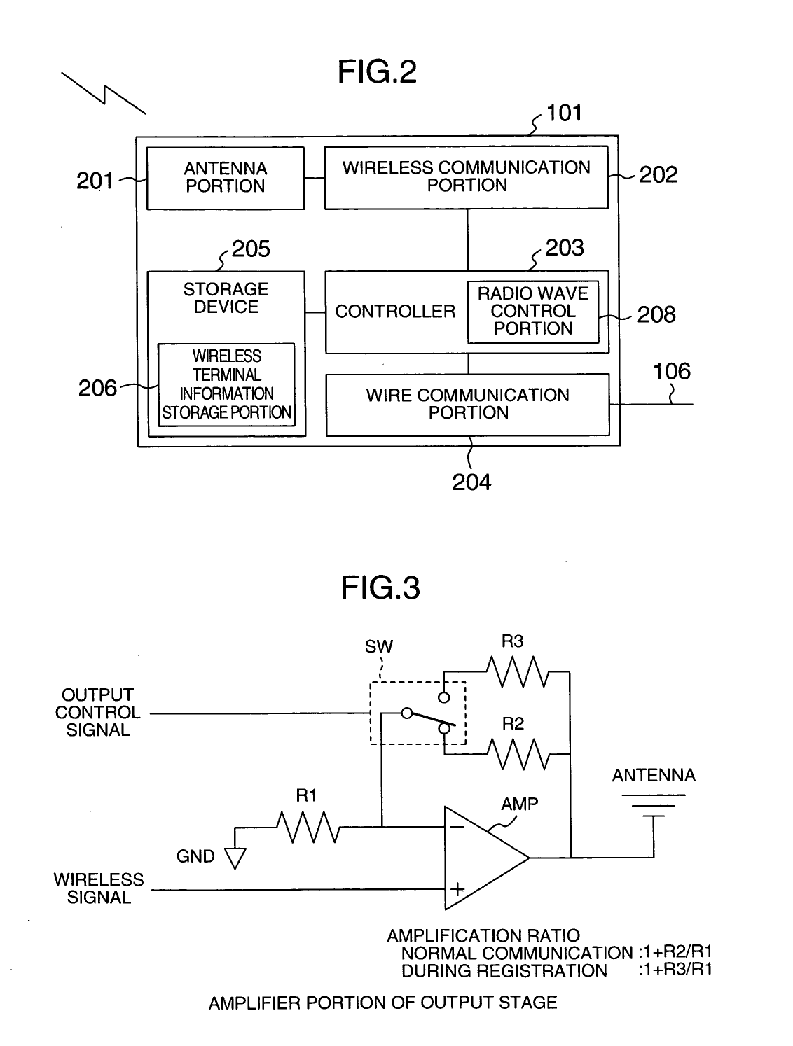

FIG. 2 is a block diagram showing a structural example of the output variable fixed base station 101. In FIG. 2, reference numeral 201 denotes an antenna portion. Reference numeral 202 denotes a wireless communication portion. Reference numeral 203 denotes a controller. Reference numeral 204 denotes a wire communication portion. Reference numeral 205 denotes a storage device. Reference numeral 206 denotes a wireless terminal information storage portion. Reference numeral 208 denotes a radio wave control portion.

The output variable fixed base station 101 includes an antenna portion 201 for outputting a wireless signal, a wireless communication portion 202 for inputting and outputting the wireless signals and executing modulation and demodulation of the wireless signals, a wire communication portion 204 for communicating with the wire network 106, a controller 203 for making control between wire and wireless communication and a storage device 205 for storing information of the wireless terminals, and so forth, as shown in FIG. 2. The output variable fixed base station 101 is connected to the wire network 106.

A wireless terminal information storage portion 206 is provided inside the storage device 205. The content of the information stored in this wireless terminal information storage portion 206 includes an MAC address of the wireless terminal registered and a cipher code used for encryption corresponding to the wireless terminal. These information is taken from the wireless terminal to the own fixed base station through wireless communication. The output variable fixed base station 101 is so constituted as to be capable of controlling the wireless output and its control is executed inside the radio wave control portion 208 of the controller 23. The output variable fixed base station 101 executes wireless transmission output control and makes it possible to execute communication only inside the communication area 102 for initial registration. When the maximum distance from the base station 101 of the normal communicable area 105 is 100 m and the communication area 102 for initial registration is 50 cm or below, for example, the wireless output may well be lowered to 1/200. In other words, the wireless output may be lowered by about 25 dB.

FIG. 3 shows a construction of the wireless output control circuit packaged to the last stage output circuit of the wireless communication portion 202. In FIG. 3, symbol SW denotes a switch, AMP denotes an amplifier and R1 to R3 denote resistors.

The circuit shown in FIG. 3 is disposed so as to control the amplification ratio of the amplifier AMP in the final stage output circuit of the wireless communication portion 202 and includes the resistors R1 to R3 and the switch SW. The switch SW is controlled by the output control signal outputted from the radio wave control portion 208 through the controller 203. The switch SW changeably connects either one of the resistors R2 and R3 to the output terminal of the amplifier AMP and to the input terminal on the negative side connected to the ground through the resistor R1. The switch SW is controlled by the output control signal.

When ordinary communication is made, the switch SW is so controlled as to connect the resistor R2 between the input/output terminals of the amplifier AMP. In consequence, the amplification ratio of this amplifier AMP is given by (1+R2/R1) and the wireless signal inputted to the input terminal of the amplifier AMP on the positive side is amplified by (1+R2/R1) times and outputted. When the registration request is made, the switch SW is so controlled by the output control signal as to connect the resistor R3 between the input/output terminals of the amplifier AMP. As a result, the amplification ratio of the amplifier AMP is (1+R3/R1) and the wireless signal inputted to the input terminal on the positive side of the amplifier AMP is amplified by (1+R3/R1) times and outputted. The wireless output can be changed over through the control of the switch SW by setting the values of the resistors R1, R2 and R3 to suitable values.

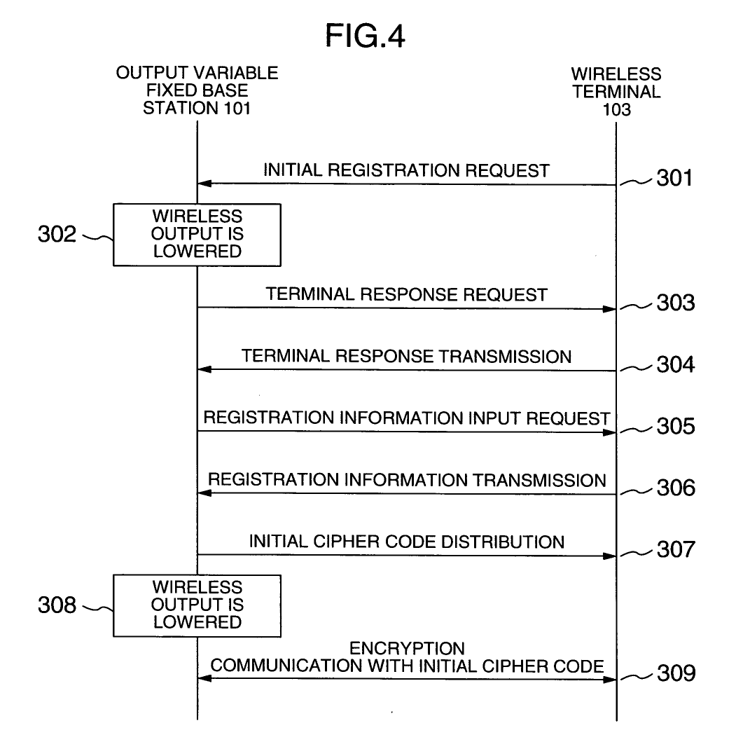

FIG. 4 is a sequence diagram for explaining the registration procedure of the user in the output variable fixed base station 101. Next, this procedure will be explained. The processing is executed by using control software provided into the controller of the output variable fixed base station 101.

(1) When the initial registration request of the user from the wireless terminal 103 occurs, the output variable fixed base station 101 receives this request and lowers the wireless output of its own base station by means of the radio wave control portion 208 so that the communicable area of the channel used by the wireless terminal 103 becomes a narrow area extremely adjacent to the own base station as the initial registration communication area 102 explained with reference to FIG. 1 (sequences 301 and 302). It will be assumed, for example, that the user having the wireless terminal 103 makes the initial registration request from the terminal 103. In this case, the user uses can make the initial registration request by means that inputs a specific address by using a Web browser, for example.

(2) After the wireless output of the own base station is lowered, the output variable fixed base station 101 requires the wireless terminal 103 to respond in reply to the initial registration request from the wireless terminal 103. When the response from the wireless terminal 103 is not acquired, the output variable fixed base station 101 judges that the wireless terminal 103 does not exist sufficiently close the own base station 101, returns the wireless output to the normal output and does not execute the subsequent processing (sequence 303).

(3) When the output variable fixed base station 101 can receive the response from the wireless terminal 103 in reply to the response request in the sequence 303, the output variable fixed base station 101 requires the wireless terminal 103 to input registration information such as the MAC address (sequences 304 and 305).

(4) The wireless terminal 103 transmits the registration information in response to the input request in the sequence 305. The output variable fixed base station 101 receives the response from the wireless terminal 103 and then distributes the cipher code to the wireless terminal 103 (sequences 306 and 307).

(5) The output variable fixed base station 101 then returns the wireless output of the own base station to the normal output and makes it possible to conduct encryption communication by using the wireless terminal 103 and the initial cipher code (sequences 308 and 309).

In the procedure explained above with reference to FIG. 4, the output of the output variable fixed base station 101 that is lowered to the output for the communication area 102 for initial registration is for only the channel used for communication with the wireless terminal to which the cipher code is given. Therefore, during the period in which the output is lowered, too, exchange with other wireless terminals that conduct communication by using other channels is continued at the output of the normal communication area 105.

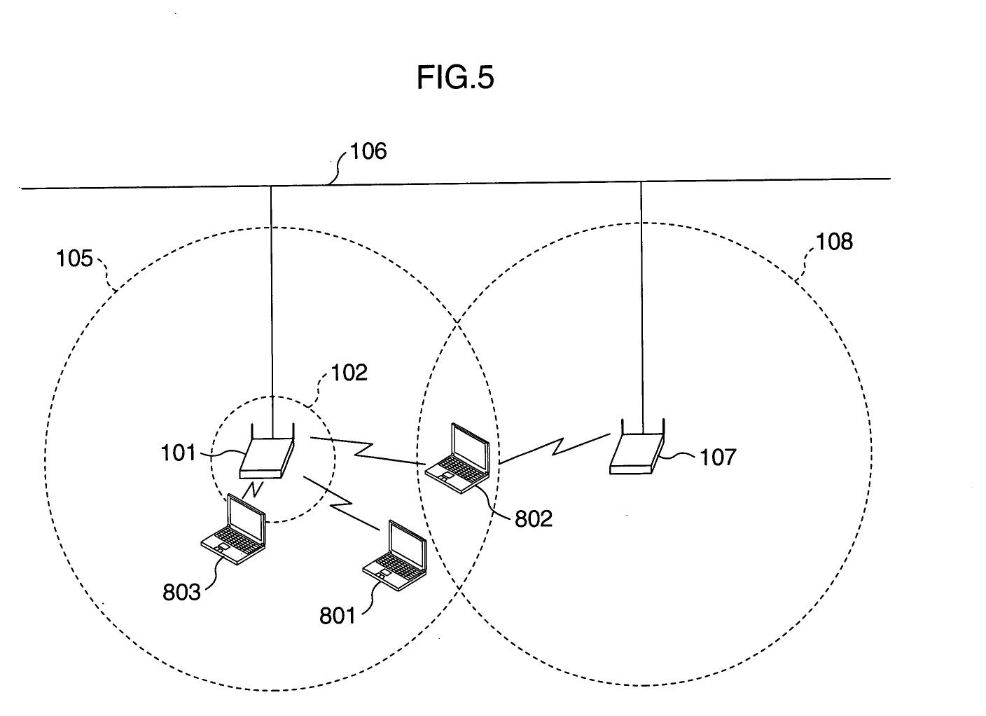

FIG. 5 explains the case where the wireless terminal using the same channel as the channel used for initial registration exists. Referring to FIG. 5, reference numerals 801 to 803 denote the wireless terminals and the rest of reference numerals are the same as those in FIG. 1. It will be assumed that wireless terminals 801 and 802 conducting normal communication exist and under this state, a wireless terminal 803 generating the initial registration request appears as shown in FIG. 5. At this time, the output variable fixed base station 101 lowers the wireless output of the channel through which the wireless terminal 803 makes the requests, in accordance with the request for initial registration from the wireless terminal 803 and reduces the communicable area to the communication area 102 for initial registration 102. Since the wireless terminal 802 exists at this time inside the communication areas 105 and 108 of both fixed base stations 101 and 107, communication can be continued through the fixed base station 107 but the wireless terminal 801 cannot because it comes off from the normal communication area 105 of the base station 101. Under such a state, too, it is preferred that communication can be made.

In this case, communication can be continued by assigning a higher priority of normal communication to initial registration and rejecting the registration request from other terminals for a predetermined period even when a registration request successively occurs immediately after registration of one terminal is complete. In other words, communication can be recovered soon after the lapse of a relatively short time in which one terminal executes initial registration.

As another method, it is possible to employ a method that transmits only a beacon at the normal output even when initial registration of one wireless terminal is made so as to prevent the output variable fixed base station 101 from disappearing.

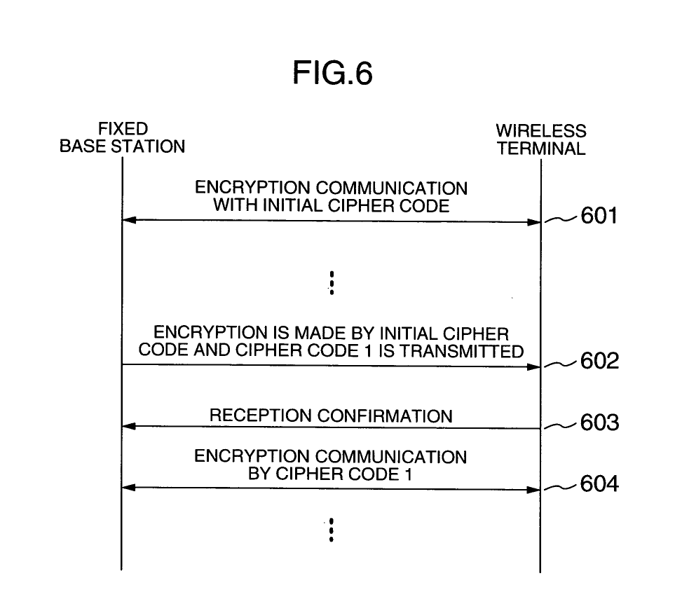

FIG. 6 is a sequence diagram for explaining a procedure for updating the cipher code distributed at the time of initial registration described above. This procedure will be explained next.

(1) As explained above, the user who has made initial registration receives the cipher code used for communication. Therefore, encryption communication is thereafter made by using the cipher code received between the fixed base station and the wireless terminal of the user (sequence 601).

(2) The fixed base station distributes the cipher code 1 ciphered by the cipher code used at present to the wireless terminals after the passage of a predetermined time or a random time (sequence 602).

(3) Receiving the updated cipher code 1, the wireless terminal reports the reception of the cipher code 1 to the fixed base station (603) and thereafter makes encryption communication by using the updated cipher code 1 (sequences 603 and 604).

(4) A new cipher key is distributed in the same way as described above after the passage of a predetermined updating time or a random time and the processing described above is repeated. The manager can arbitrarily set the updating time of the cipher code.

The explanation of the first embodiment of the invention given above is based on the assumption that one fixed base station executes both initial registration of the user and normal communication. However, the invention may include a fixed base station dedicated to initial registration of the user.

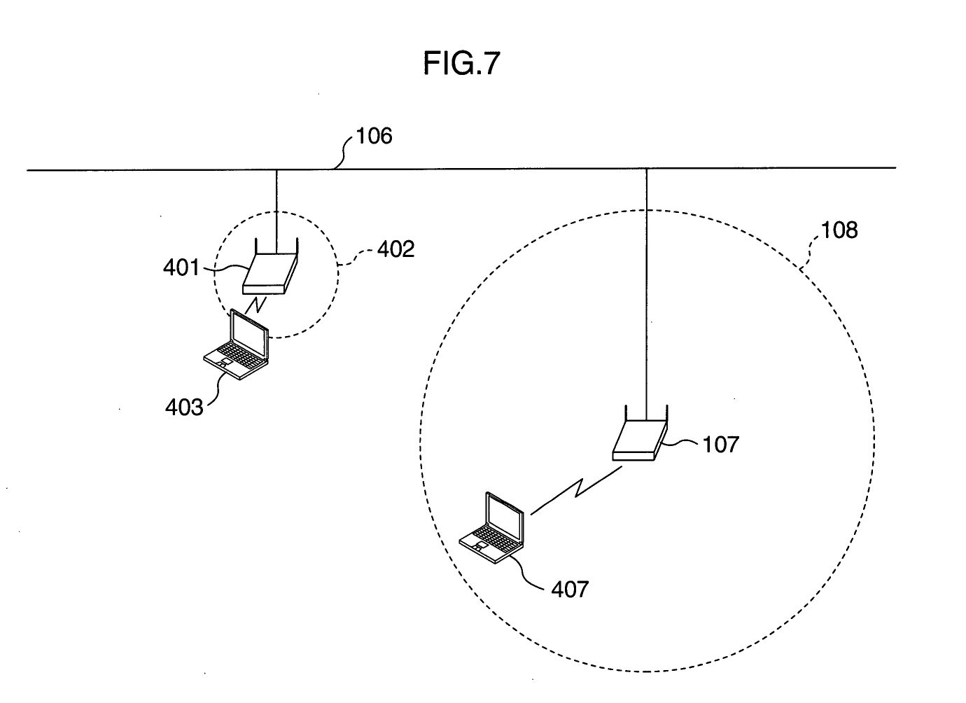

FIG. 7 is a block diagram showing a basic construction of a wireless network system according to the second embodiment of the invention. The second embodiment represents a structural example where the dedicated fixed base station for initial registration of the user is provided. Referring to FIG. 7, reference numeral 401 denotes a fixed base station for initial registration. Reference numeral 402 denotes a communication area for initial registration. Reference numerals 403 and 407 denote wireless terminals and other reference numerals are the same as those of FIG. 1.

In the wireless network system shown in FIG. 7, the fixed base station 401 for initial registration is connected to other fixed base station 107 through the wire network 106. The wireless output of the fixed base station 401 for initial registration is lowered so that communication can be made inside only the communication area 402 for initial registration. The fixed base station 401 for initial registration is used only when the wireless terminal 403 for which initial registration is to be made is registered. The fixed base station 107 is a fixed base station having an ordinary wireless output used for normal communication and conducts communication with the wireless terminals 403 and 407 after registration. The fixed base station 401 for initial registration and the fixed base station 107 are connected to other fixed base stations and to a network such as the Internet. As shown in FIG. 7, the fixed base station 401 for initial registration can make communication inside an area extremely close to the own fixed base station 401 for initial registration as the communication area 402 for initial registration.

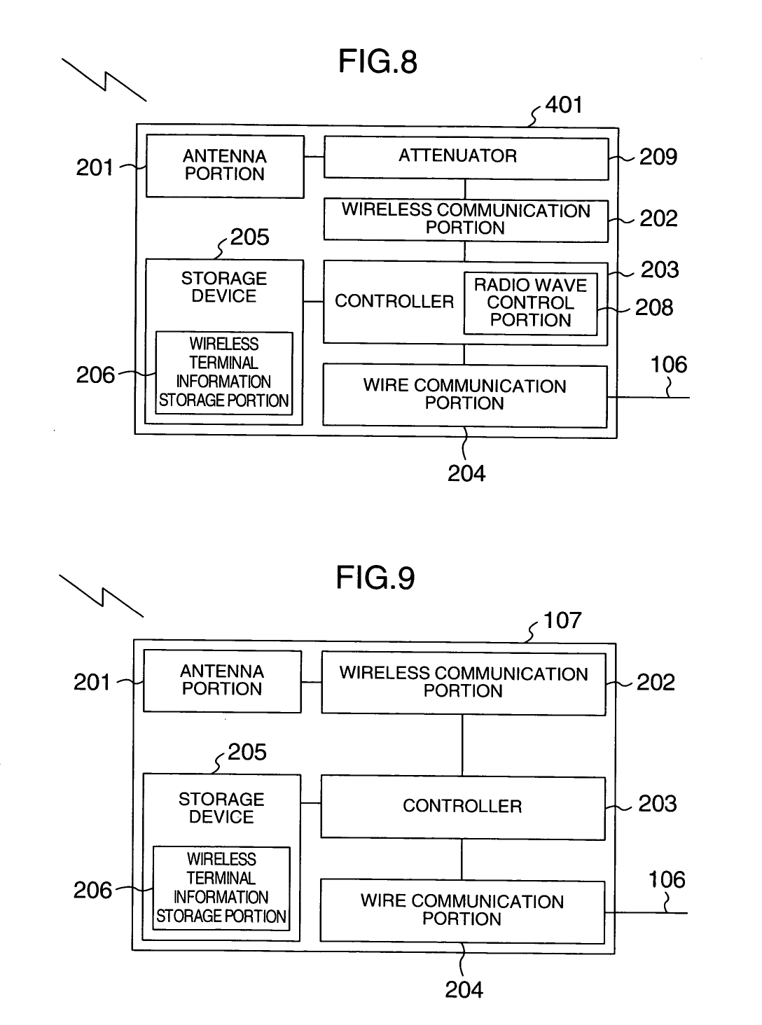

FIG. 8 is a block diagram showing a structural example of the fixed base station 401 for initial registration. Referring to FIG. 8, reference numeral 209 denotes an attenuator and other reference numerals are the same as those shown in FIG. 2.

The fixed base station 401 for initial registration includes an antenna portion 201 for outputting wireless signals, a wireless communication portion 202 for modulating and demodulating the wireless signals, a wire communication portion 204 for exchanging the signals with the wire network, a controller 203 for controlling wire and wireless communication and a storage device 205 for building up identification information of the own fixed base station and information of frequency bands or for storing information of the wireless terminals. The fixed base station 401 for initial registration is connected to the wire network 106.

A wireless terminal information storage portion 206 is provided inside the storage device 205. The content of the information stored in the wireless terminal information storage portion 206 includes the MAC addresses of the wireless terminals registered, the cipher code used for encryption, and so forth. These information include those which are fetched from the wireless terminal to the own fixed base station through wireless communication and those which are fetched from other fixed base stations to the own fixed base station through the wire network 106. Therefore, even when a plurality of fixed base stations exists, the wireless terminal can make communication on the basis of the registration information that has already been registered.

The fixed base station 401 for initial registration controls the wireless output by steadily setting the output of the radio wave inside the radio wave control portion 208 of the controller 203 to lower the radio wave output or by interposing the attenuator 209, or the like, between the antenna 201 and the wireless communication portion 202. In other words, the wireless output is controlled so that communication can be made only with the wireless terminal extremely close to the fixed base station 401 for initial registration.

When the initial registration request from the wireless terminal 403 occurs in the second embodiment of the invention having the construction described above, only the fixed base station 401 for initial registration accepts the request and the fixed base station 107 does not accept the request even when the wireless terminal 403 exists inside the normal communication area of the fixed base station 107. The fixed base station 401 for initial registration registers the wireless terminal 403 to the own base station in accordance with the initial registration request from the wireless terminal 403 and transmits the cipher code to the wireless terminal 403. The initial registration request from the wireless terminal 403 is made by means that inputs a specific address by using a Web browser, for example.

After registration of the wireless terminal 403 is complete, the fixed base station 401 for initial registration transmits the registration information of the wireless terminal 403 and the cipher code to the fixed base station disposed inside this system inclusive of the fixed base station 107 through the wire network 106. Consequently, the wireless terminal 403 thereafter moves as the wireless terminal 407 inside the normal communication area 108 and can make communication by utilizing the fixed base station 107. Subsequent updating of the cipher code is made in accordance with the sequence shown in FIG. 6 in the same way as in the first embodiment.

The fixed base station 107 representing the system construction of the first and second embodiments of the invention explained above and shown in FIGS. 1 and 7 is a fixed base station having a normal wireless output. A plurality of such fixed base stations 107 can be installed inside the system.

FIG. 9 is a block diagram showing a structural example of the fixed base station 107. Reference numerals in FIG. 9 are the same as those in FIG. 2.

The fixed base station 107 includes an antenna portion 201 for outputting wireless signals, a wireless communication portion 202 for modulating and demodulating the wireless signals, a wire communication portion 204 for exchanging the signals with the wire network, a controller 203 for controlling wire and wireless communication and a storage device 205 for building up identification information of the own fixed base station and information of frequency bands or for storing information of the wireless terminals. The fixed base station 107 is connected to the wire network 106. A wireless terminal information storage portion 206 is provided inside the storage device 205. The content of the information stored in the wireless terminal information storage portion 206 includes the MAC addresses of the wireless terminals registered, the cipher code used for encryption, and so forth. These information are fetched to the own fixed base station through the wire network 106.

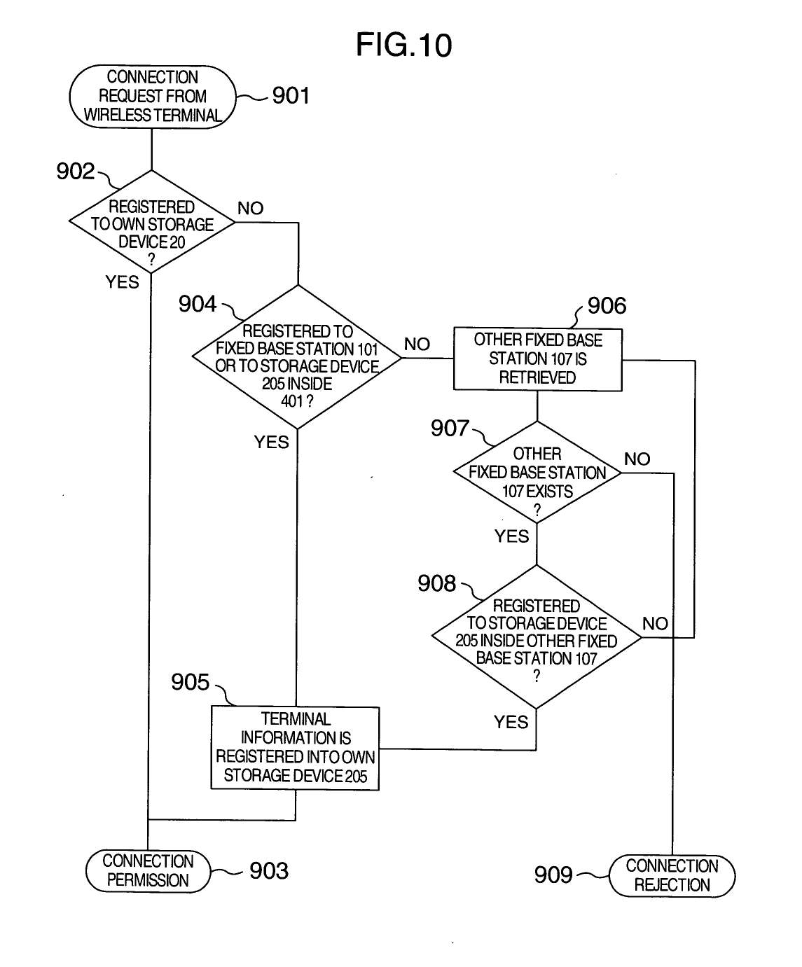

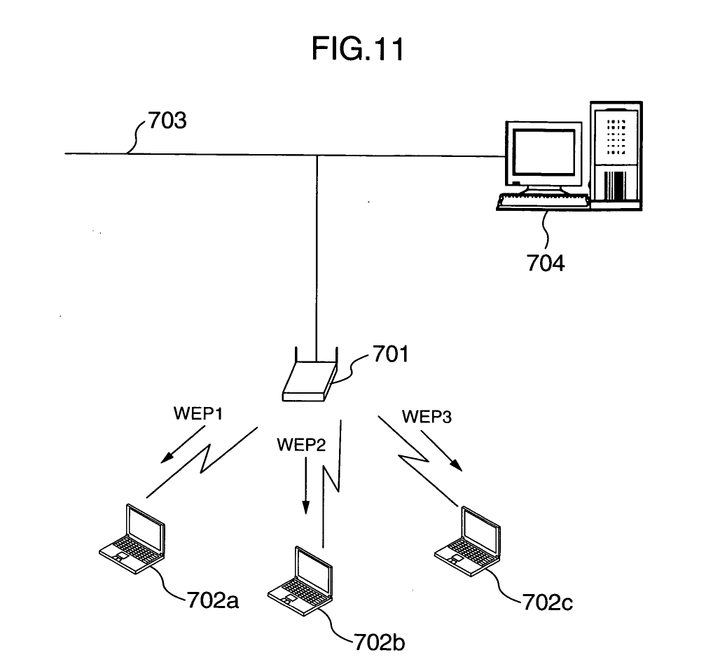

FIG. 10 is a flowchart for explaining a connection permission procedure when the connection request is raised from the wireless terminal to the fixed base station 107. Next, this procedure will be explained.

(1) When the connection request occurs from the wireless terminal, the fixed base station 107 first refers to the wireless terminal information storage portion 206 inside the storage device 205 of its own fixed based station and judges whether or not the wireless terminal making the connection request is registered. When the connection request is from the wireless terminal registered to the wireless terminal information storage portion 206, the fixed base station 107 permits the connection of the wireless terminal (steps 901 to 903).

(2) When the connection request is found from the wireless terminal not registered to the wireless terminal information storage portion 206 in the judgment of step 902, whether or not the registration information of the wireless terminal making the registration request to other fixed base station exists is confirmed. When the output variable fixed base station 101 or the fixed base station 401 for initial registration exists inside the network, the output variable fixed base station 101 or the fixed base station 401 for initial registration is first looked up and whether or not the registration of the wireless terminal making the registration request exists is judged (step 904).

(3) When the registration information of the wireless terminal making the registration request is found existing in the output variable fixed station 101 or in the fixed base station 401 for initial registration in the judgment of step 904, the wireless terminal information is received from the fixed base station and is registered to the wireless terminal information storage portion 206 of the own base station. Connection of that wireless terminal is then permitted (steps 905 and 903).

(4) When the registration information of the wireless terminal making the registration request is not found existing in the output variable fixed base station 101 or in the fixed base station 401 for initial registration in the judgment of step 904, other fixed base station 107 is searched and whether or not the fixed base station 107 to be looked up exists is judged. The absence of other base stations is judged by time-out for the request (steps 906 and 907).

(5) When the fixed base station 107 to be looked up does not exist in the judgment of step 907, the registration information of the wireless terminal is not found and the connection request from that wireless terminal is rejected (step 909).

(6) When the fixed base station 107 to be looked up is found existing in the judgment of step 907, whether or not the registration information of the wireless terminal making the registration request is registered to the fixed base station is judged. When it is not registered, the flow returns from the step 906 and the processing is repeated by searching whether or not other fixed base station exists (step 908).

(7) When the registration information of the wireless terminal making the registration request is registered to the fixed base station 107 looked up in the judgment of the step 908, the wireless terminal information is received from that fixed base station and is registered to the wireless terminal information storage portion 206 of the own base station. The connection of that wireless terminal is thereafter permitted (steps 905 and 903).

The processing in the embodiment described above can be constituted as a processing program. This processing program can be stored in a recording medium such as HD, DAT, FD, MO, DVD-ROM, CD-ROM, etc, and can be offered.

According to the embodiments of the invention described above, the cipher code used for communication can be distribute by safely executing the initial registration of the user by using only the wireless apparatus as the fixed base station without using the authentication server for the user, can limit the cost of the entire system and can reduce the burden to the manager because management of the authentication server is not necessary.

Subsequent updating of the cipher code can be made in normal communication and decryption of the cipher code by the third party becomes therefore difficult.

The invention can distribute the cipher code used for communication by safely making the initial registration of the user by using only the wireless apparatus as the fixed base station, can limit the cost of the entire system and can reduce the burden to the manager.

Because subsequent updating of the cipher code can be made in normal communication, decryption of the cipher code by the third party becomes difficult.

It should be further understood by those skilled in the art that although the foregoing description has been made on embodiments of the invention, the invention is not limited thereto and various changes and modifications may be made without departing from the spirit of the invention and the scope of the appended claims.

1. A method for distributing a cipher code in a wireless network system including a mobile terminal and fixed station, comprising the steps of:
making a registration request from a mobile terminal to said fixed station as a terminal with which communication is to be made;
changing a communication range of said fixed station in accordance with said registration request so that communication can be made with said one mobile terminal; and
distributing an initial cipher code from said fixed base station to said mobile terminal under the state where said communication range changed.

2. A method for distributing a cipher code according to claim 1, further comprising the step of narrowing the communication range of said fixed station by lowering a wireless output of said fixed station.

3. A method for distributing a cipher code according to claim 1, further comprising the step of distributing the initial cipher code from said fixed station to said mobile terminal and returning the wireless communication range of said fixed station to the wireless communication range before the registration request from said mobile terminal is accepted.

4. A method for distributing a cipher code according to claim 1, further comprising the steps of narrowing the wireless communication range of said fixed station, confirming a response from said mobile terminal making the registration request and when the response is not made, interrupting a registration processing of said mobile terminal and returning the wireless communication range of said fixed station to the wireless communication range before the registration request from said mobile terminal is accepted.

5. A method for distributing a cipher code according to claim 1, further comprising the step of registering terminal information of said mobile terminal to said fixed station when said initial cipher code is distributed to said mobile terminal.

6. A method for distributing a cipher code according to claim 5, wherein terminal information of said mobile terminal includes an MAC address of said mobile terminal and the initial cipher code distributed to said mobile terminal.

7. A method for distributing a cipher code according to claim 5, further comprising the step of transmitting terminal information of said mobile terminal to other fixed station of a network to which said fixed station is connected.

8. A method for distributing a cipher code according to claim 7, further comprising the step of inquiring registration information of said mobile terminal to other fixed station when said mobile terminal is not registered to a fixed station to which said mobile terminal gains access.

9. A method for distributing a cipher code according to claim 1, wherein, when a terminal registration request occurs from said mobile terminal to said fixed station and when said fixed station is under communication with other mobile terminal, a processing for said terminal registration request is executed after said communication is complete.

10. A method for distributing a cipher code according to claim 1, wherein said initial cipher code has a validity time, and a cipher code after the validity time that is encrypted by said initial cipher code is distributed from said fixed station to said mobile terminal.

11. A method for distributing a cipher code according to claim 1, wherein said fixed station distributing said initial cipher code has a specific address, said mobile terminal makes the registration request to said specific address and said initial cipher code is distributed after authentication is made between said fixed station and said mobile terminal.

12. A wireless network system for executing wireless communication between a mobile terminal and a fixed station, wherein:
said fixed station includes registration control means for executing registration control of said mobile terminal in accordance with a registration request from said mobile terminal, a wireless radio wave output control portion for reducing a wireless output of said fixed station in accordance with an instruction from said registration control means and cipher code distribution means for distributing an initial cipher code to said mobile terminal making the registration request in accordance with the instruction from said registration control means after the wireless output is lowered; and
said mobile terminal includes registration request means for requesting registration of said mobile terminal to said fixed station and cipher code reception means for receiving the initial cipher code distributed from said fixed station.

13. A wireless network system according to claim 12, wherein said wireless radio wave output control portion returns to a normal radio wave output after the initial cipher code is distributed to said mobile terminal.

14. A wireless network system according to claim 12, wherein said wireless radio wave output control portion returns to a normal radio wave output when said mobile terminal does not exist in a communication range having a reduced wireless output and a response from said mobile terminal does not exist.

15. A wireless network system according to claim 12, wherein said fixed station includes a mobile terminal information recording portion for recording identification information of a mobile terminal making the registration request and said initial cipher code, and transfers mobile terminal information recorded to said mobile terminal information recording portion to other fixed station connected to the same network as said fixed station.

16. A wireless network system according to claim 12, which further includes other fixed station connected to the same network as said fixed station, and wherein said mobile terminal and said other fixed station execute wireless communication by using a cipher code encrypted by said initial cipher code.

17. A wireless network system according to claim 12, wherein a wireless communication range when said fixed station distributes said initial cipher code is 50 cm or below.

18. A wireless network system according to claim 12, wherein said wireless radio wave output control portion steadily outputs a beacon of a normal output even while the wireless output is lowered to distribute said initial cipher code to said mobile terminal.

19. A wireless network system for executing wireless communication between a mobile terminal and a plurality of fixed stations, wherein:
a first fixed station is a fixed station that has a small communication range and distributes an initial cipher code to said mobile terminal; and
a second fixed station is a fixed station that receives registration information of said mobile terminal from said first fixed station and executes wireless communication with said mobile terminal.

20. A wireless network system according to claim 19, wherein said second fixed station executes wireless communication while periodically updating the cipher code of wireless communication with said mobile terminal, distributes a cipher code after updating to said mobile terminal with a cipher code before updating when the cipher code is updated, and when said second fixed station and said mobile terminal first execute wireless communication, wireless communication is made by using an initial cipher code distributed from said first fixed station.
